(19) United States
(12) Patent Application Publication
(10) Pub. No.: US 2012/0196950 A1
(43) Pub. Date: Aug. 2, 2012

(54) BIODEGRADABLE POLYMER COMPOSITION WITH CALCIUM CARBONATE AND METHODS AND PRODUCTS USING SAME

(75) Inventors: Paul Weismann, San Diego, CA (US); Sandee Whiteman, Los Angeles, CA (US)

(73) Assignee: C-STONE LLC, San Diego, CA (US)

(21) Appl. No.: 13/443,724

(22) Filed: Apr. 10, 2012

Related U.S. Application Data
(62) Division of application No. 12/987,963, filed on Jan. 10, 2011.
(60) Provisional application No. 61/293,566, filed on Jan. 8, 2010.

(51) Int. Cl. C08L 67/04; C08K 3/26

(52) U.S. Cl. 523/100; 524/425

(57) ABSTRACT

Described herein are biodegradable compositions, methods for making these compositions, and applications using these compositions. In one embodiment, a process of manufacturing paper or other products is provided using a composition comprising a mixture of 25% to 80% calcium carbonate along with a biodegradable biopolymer matrix made from renewable resources including polylactic acid (“PLA”), soy proteins, polyhydroxyalkanoate (“PHA”), polyhydroxybutyrate (“PHB”), and/or starch from corn, wheat, tapioca, potatoes, or similar renewable resource products.

### CROSS-REFERENCE TO RELATED APPLICATIONS

This application is a divisional of U.S. patent application Ser. No. 12/987,963, filed Jan. 10, 2011, and entitled “BIODEGRADABLE POLYMER COMPOSITION WITH CALCIUM CARBONATE AND METHODS AND PRODUCTS USING SAME,” which claims the benefit of priority under 35 U.S.C §119(e) of U.S. Provisional Application No. 61/293,566 filed on Jan. 8, 2010, and entitled “A process of manufacturing paper products using mixture of 25 to 80% Calcium Carbonate powder and other minerals mixture along with biodegradable bio-polymer matrix made from renewable resources including polylactic acid or polylactide (PLA), soy proteins, PHAs, PHBs, or starch from corn, wheat, tapioca, potatoes or similar renewable resource products,” all of which are hereby incorporated herein by reference in their entirety and are to be considered a part of this specification.

### BACKGROUND

1. Field

Embodiments of the invention relate generally to biodegradable compositions, methods for making these compositions, and applications using these compositions. In one embodiment, a process of manufacturing paper or other products is provided using a composition comprising a mixture of 25% to 80% calcium carbonate along with a biodegradable biopolymer matrix made from renewable resources including polylactic acid (“PLA”), soy proteins, polyhydroxyalkanoate (“PHA”), polyhydroxybutyrate (“PHB”), and/or starch from corn, wheat, tapioca, potatoes, or similar renewable resource products.

2. Description of the Related Art

Petroleum-based plastics are used routinely in such applications as paper, packaging materials, utensils and cutlery, food containers, as well as many others. More than 400 billion pounds of plastic are produced each year is the U.S. alone, accounting for nearly 10% of total U.S. oil consumption. Such materials are desirable by retailers and consumers because they may be simply disposed of after use and do not need to be washed or reused.

The widespread and growing use of such disposable materials results in a mounting amount of litter produced each day. Plastic litter may either be incinerated or it may accumulate in a refuse dump. More than 60 million plastic petroleum-based water bottles end up in landfills every day. Since these plastics do not decay in soil, landfills, rivers or oceans, these methods of waste disposal have the potential to cause many problems for the environment.

For preparing the above-mentioned items, biodegradable polymers are already known in the art and comprise materials such as poly(glycolic acid), poly(epsilon-caprolactone), PLA, and polydioxanone. The production of these polymers can be cumbersome and expensive, so their use may be restricted to high value applications. Another limitation with polylactic acid specifically is that it lacks the level of heat resistance present in petroleum based plastics, under typical processing conditions used in the industry.

There then exists a demand to provide a composition which is degraded in a natural environment in a time period which is significantly shorter than the amount of time required for the degradation of conventional plastic materials, such as polyethylene, polypropylene, or polystyrene. There also exists a demand to reduce the amount of biodegradable polymer resin that may be cumbersome or expensive to produce.

### SUMMARY

In view of the foregoing, there are described herein biodegradable compositions, methods for making these compositions, and applications using these compositions. In certain embodiments, these compositions comprise a mixture of 25% to 80% calcium carbonate by weight based on the total weight of the composition along with a biodegradable biopolymer matrix made with renewable resources.

When the desired end product is determined, a mixture of calcium carbonate and other inorganic mineral powders and biodegradable resins and additives are combined in a specific formula for that end use. Manufacturing processes such as melting, coating, stretching, laminating and/or any other such suitable manufacturing process may be used to make the desired end product.

A product such as a pellet may be formed by combining the mixture of inorganic mineral powders consisting of primarily calcium carbonate and forming granulates where the inorganic mineral powders comprise 25% to 80% of the total weight of the composition, with a biodegradable renewable resource resin and 1% to 2% of additives by weight comprising 25% to 80% of the total weight of the composition, by the steps of mixing, extruding, or milling the inorganic mineral powders, the biodegradable renewable resource resin, and the additives. For example, according to an embodiment, a method for making the composition into a paper film consists of using at least one extruder. The biodegradable material composition may be melted in the extruder, molded, and cooled and stretched to the desired product thickness and consistency. The biodegradable material composition may also be subject to applicable coatings, cuttings, and finishing.

The biodegradable material composition may be adjusted for specific end uses which could include similar properties to high density polyethylene (HDPE) plastic products or pulp paper products and may have comparable properties to such products, such as stiffness, opaqueness, foldability, ability to retain ink or graphite from writing utensils, and tearing strength. The biodegradable material composition may also be adjusted for use in such applications as signs, packaging, boxes, food containers, bags, labels, maps, books, newspapers and magazine, trays, credit cards and room keys, architectural drawings, decoration, wall coverings and other similar and non-similar uses. Other foreseeable applications for the composition mixture may include, but are not limited to parts of insulation, moisture barriers, window coverings, office supplies, various specialty containers, as well as any application where the material may be suitable as a substitute for petroleum-based plastics.

An end product made from the composition may be water resistant and may be used for an application requiring waterproofing or water repelling characteristics.

An end product made from the composition may also be manufactured in single, double, triple, and/or additional layers depending on the desired end use. The layers may also be laminated to modify properties and uses. According to some embodiments, layers of the same material may be laminated on the biodegradable composition. According to other embodiments, one or more different materials may be laminated on the composition.

Current similar non wood paper products include HDPE products or resins and are not biodegradable. According to embodiments of the invention, this product may replace the HDPE in plastic products with a biodegradable component.

According to one embodiment a biodegradable composition is described that comprises a biodegradable polymer and an inorganic filler including calcium carbonate. The calcium carbonate may comprise 25-80% (or about 25 to about 80%) by weight of the composition. According to some embodiments, the biodegradable polymer may be polylactic acid. According to other embodiments, the composition may further include a starch. The starch in certain embodiments may be derived from one or more of corn, wheat, tapioca, or potatoes. The calcium carbonate may be wet ground. In other embodiments, the calcium carbonate may be dry ground. According to some embodiments, some or all of the particles of calcium carbonate have a median particle size of 0.8 microns (or about 0.8 microns) or less. According to some embodiments, a mixture of calcium carbonate is formed by combining greater than 65% (or about 65%) by weight of a first sample of calcium carbonate having a median particle size of 1.5 microns (or about 1.5 microns) or greater with less than 35% (or about 35%) by weight of a second sample of calcium carbonate having a median particle size of 0.8 microns (or about 0.8 microns) or less. According to some embodiments, some or all of the particles of calcium carbonate have a median particle size of 1.5 microns (or about 1.5 microns) or less. A printable sheet may be formed from the aforementioned biodegradable composition. In some embodiments, the printable sheet comprises 45% to 60% (or about 45% to about 60%) by weight of calcium carbonate. A food service product may be formed from the aforementioned biodegradable composition. In some embodiments, the food service product comprises 30% to 45% (or about 30% to about 45%) by weight of calcium carbonate.

According to another embodiment, a food service product is disclosed that includes a composition including a biopolymer including PLA, between 30% and 45% (or about 30% and about 45%) by weight calcium carbonate, and a starch. According to another embodiment, a printable sheet is disclosed that includes a biopolymer including PLA, between 45% and 60% (or about 45% and about 60%) calcium carbonate, and a starch.

### BRIEF DESCRIPTION OF THE DRAWINGS

FIG. 1 is a schematic view of a process for making and processing a biodegradable polymer composition according to an embodiment of the invention.

### DETAILED DESCRIPTION OF THE PREFERRED EMBODIMENT

The following description discloses a new biodegradable material composition and methods for forming the biodegradable material composition. Also, various end products and methods for making those end products comprising a biodegradable material composition are disclosed. The disclosed biodegradable material composition can be incorporated into a variety of end products, including signs, packaging, boxes, food containers, bags, labels, maps, books, newspapers and magazine, trays, credit cards and room keys, architectural drawings, decoration, wall coverings, parts of insulation, moisture barriers, window coverings, office supplies, various specialty containers, as well as any application where the material may be suitable as a substitute for petroleum-based plastics.

Various processing methods that can be used to create end products with the biodegradable material composition include such materials processing methods as extrusion, thermoforming, injection molding, vacuum forming, blow molding, and rotational molding.

The term “biodegradable material” as used herein pertains to a degradable material in which the degradation results from the action of naturally occurring microorganisms such as bacteria, fungi, and algae. A degradable material such as a degradable plastic is a plastic designed to undergo a significant change in its chemical structure under specific environmental conditions, resulting in a loss of some properties that may be measured by standard tests methods appropriate to the plastic and the application in a period of time that determines its classification. Depending on the additional components present in the composition and the dimensions of the object made from said biodegradable material, the time period required for degradation will vary and may also be controlled. Generally, the time span for biodegradation will be significantly shorter than the time span required for a degradation of objects made from conventional plastic materials having the same dimensions, such as polyethylene. According to ASTM 6400 D99, a compostable plastic would need to biodegrade within less than 180 days to be classified as such. For example, a PLA-based article would degrade in compost environment in weeks.

A biodegradable material composition according to an embodiment comprises a biodegradable polymer and an inorganic filler comprising calcium carbonate comprising between 25% and 80% (or about 25% and about 80%) by weight, preferably between 30% and 65% (or about 30% and about 65%) by weight, more preferably between 30% and 50% (or about 30% and about 50%) by weight, of the total weight of the biodegradable composition. The biodegradable polymer may preferably comprise polylactic acid and comprise between 20% and 75% (or about 20% and about 75%) by weight of the end product weight. The composition, according to other embodiments, also contains a starch. In some embodiments, the starch comprises between 10% and 25% (or about 10% and about 25%) by weight. In other embodiments the starch comprises between 15% and 20% (or about 15% and about 20%) by weight. The starch may be derived from such sources as corn, wheat, tapioca, potatoes or similar sources.

Calcium carbonate may be represented by the chemical compound CaCO₃ and may be found in nature. According to embodiments of the biodegradable material composition, the addition of the above-described percentages of calcium carbonate may effectively add desirable properties such as increased flexibility, impact resistance, and heat resistance without compromising the structural stability of the material composition.

Calcium carbonate may be treated before it is added to the biodegradable material composition. For example, according to an embodiment, the calcium carbonate may be treated with a surface treatment to enhance dispersion and adhesion to a matrix polymer. The treatment may comprise any suitable treatment, including stearic acid to assist in formation of the material. In another embodiment, the calcium carbonate used may combine both wet ground and dry ground calcium carbonate, for example, in a ratio of 1:1 (or about 1:1). Calcium carbonate may also be combined with magnesium carbonate or other suitable materials to comprise an inorganic filler, for example 1 to 3 wt. % (or about 1 to about 3 wt. %), more preferably 2 wt. % (or about 2 wt. %) magnesium carbonate based on the total weight of inorganic filler added.

According to an embodiment, for example when the calcium carbonate is provided in powdered form, the calcium carbonate comprises particles with a controlled particle size distribution. The particles of calcium carbonate may be relatively or substantially spherical. According to another embodiment, the particles of calcium carbonate may be ovular or round. In one embodiment, the calcium carbonate particles may have a specific surface area of 3.3 m²/g to 9.5 m²/g (or about 3.3 m²/g to about 9.5 m²/g).

The calcium carbonate when added to the biodegradable material composition will exhibit a particle size distribution, for example, between 0.2 microns and 10 microns (or about 0.2 to about 10 microns). A median particle size is the size of particle below which 50% of the particles fall by weight. The median particle size may also be referred to as the median particle diameter. The particle size distribution according to this embodiment may have a median particle size of 2 microns (or about 2 microns) or less, 1.5 microns (or about 1.5 microns) or less, 1 micron (or about 1 micron) or less, 0.8 microns (or about 0.8 microns) or less, or 0.5 microns (or about 0.5 microns) or less.

According to another embodiment, the calcium carbonate utilized may exhibit a bimodal particle size distribution. In yet another embodiment, a combination of at least two samples of calcium carbonate particles having two distinct median particle sizes may be mixed together to comprise the calcium carbonate of the biodegradable material composition. In this embodiment, the particle size distribution may exhibit a first median particle size of 2 microns (or about 2 microns) or less, 1.5 microns (or about 1.5 microns) or less, 1 micron (or about 1 micron) or less, or 0.8 microns (or about 0.8 microns or less) or less, and exhibit a second median particle size of 1 micron (or about 1 micron) or more, 1.5 microns (or about 1.5 microns) or more, 2 microns (or about 2 microns) or more, or 3 microns (or about 3 microns) or more. According to some embodiments a different percentage by weight of the first sample and the second sample of calcium carbonate may be combined to comprise the calcium carbonate of the biodegradable material composition. According to another embodiment, the same percentage by weight of the first sample and the second sample of calcium carbonate may be combined to comprise the calcium carbonate of the biodegradable material composition. According to one embodiment, a mixture of calcium carbonate is formed that comprises 60% (or about 60%) or more by weight of a first sample of calcium carbonate having a median particle size of 2 microns (or about 2 microns) or more, combined with 40% (or about 40%) or less by weight of a second sample of calcium carbonate having a median particle size of 0.5 microns (or about 0.5 microns) or less. According to another embodiment, a mixture of calcium carbonate is formed that comprises 75% (or about 75%) or more by weight of a first sample of calcium carbonate having a median particle size of 1.5 microns (or about 1.5 microns) or more, combined with 25% (or about 25%) or less by weight of a second sample of calcium carbonate having a median particle size of 0.5 microns (or about 0.5 microns) or less. Selection of the particle size of the calcium carbonate, and for example the use of two distinct particle size distributions of two different samples of calcium carbonate, may contribute to the packing of the calcium carbonate particles in the biodegradable material composition.

According to one embodiment, about 25% by weight of Omyacarb® UFT-FL ultrafine wet ground calcium carbonate obtained from Omya Inc. having a median particle size of 0.7 microns was combined with about 75% by weight of Omyacarb® 2 SS T-SY fine wet ground calcium carbonate obtained from Omya Inc. having a median particle size of 2.0 microns. Both Omyacarb® UFT-FL and 2 SS T-SY are surface treated with stearic acid. The Omyacarb® UFT-FL includes 98% calcium carbonate, 1% magnesium carbonate, and 1.1% surface treatment including stearic acid. This material has a Y Brightness of 95.5, 7 ppm retained on 325 mesh, and a moisture loss of 0.05% at 110° C. The material has a Hegman value of 5.5, a specific gravity of 2.7, and a mean refractive index of 1.57. In addition to the median particle size of 0.7 microns, the material has a D₉₀ of 2 microns, a D₆₅ of 1 micron, and a specific surface area of 9.5 m²/g. The Omyacarb® 2 SS T-SY includes 98% calcium carbonate, 2% magnesium carbonate, and 0.8% surface treatment including stearic acid. This material has a Y Brightness of 97, 1 ppm retained on 325 mesh, and a moisture loss of 0.03% at 110° C. The material has a specific gravity of 2.7 and a mean refractive index of 1.57. In addition to the median particle size of 2.0 microns, the material has a top cut of 10 microns and a specific surface area of 3.3 m²/g.

A biodegradable polymer resin for the biodegradable material composition may comprise PLA, soy proteins, PHAs, PHBs, or any other suitable biodegradable polymer, preferably PLA. PLA is a thermoplastic aliphatic polyester that may be derived from renewable resources. PLA is beneficial, in part, because it can be composted. PLA can be prepared according to any method known in the state of the art. For example, PLA can be prepared from lactic acid and/or from one or more of D-lactide (i.e. a dilactone, or a cyclic dimer of D-lactic acid), L-lactide (i.e. a dilactone, or a cyclic dimer of L-lactic acid), meso D,L-lactide (i.e. a cyclic dimer of D-, and L-lactic acid), and racemic D,L-lactide. Preferably the PLA may have a number average molecular weight of 70,000 to 120,000 and an overall D content between 1 and 10%

According to an embodiment, the biodegradable material composition comprising PLA and 25 to 80% by weight of the composition of calcium carbonate (or other compositions described above) may advantageously show only a slight reduction in molecular weight of the PLA during typical melt processing as evidenced by the ability to satisfactorily process the compositions and the ultimate mechanical performance. If significant melt degradation had occurred the melt flow would be too high to provide for satisfactory processing and mechanical properties would be adversely affected. The biodegradable material composition may also advantageously shows an increase in biodegradation rate as compared to other mineral fillers known in the art.

The composition, according to other embodiments, may also contain a starch. The starch may be derived from such sources as corn, wheat, tapioca, potatoes or similar sources.

Other additives may be added to the biodegradable composition to affect the properties of the composition. Types of additives that may be added include, but are not limited to, plasticizers, flow modifiers, branching agents, binders, and/or other minerals. According to an embodiment, additives may comprise between 0.5% and 20% (or about 0.5% and about 20%), preferably between 1% and 2% or about 1% and about 2%), of the total weight of the composition.

The composition, and particularly the selection of calcium carbonate as described above, may lead to many desirable properties. For example the composition after it is formed and processed may exhibit a heat resistance of 150° F. to 250° F., preferably 180° F. to 250° F.

A composition according to embodiments of the invention may be obtained by mixing or blending the respective components of the biodegradable composition in the desired amounts. They may be performed according to any method known by a person of skill in the art. According to a preferred embodiment, PLA starting materials may be obtained from Natureworks LLC or any PLA supplier or distributor. Biodegradable starch-based compounded resins are also available from Cereplast.

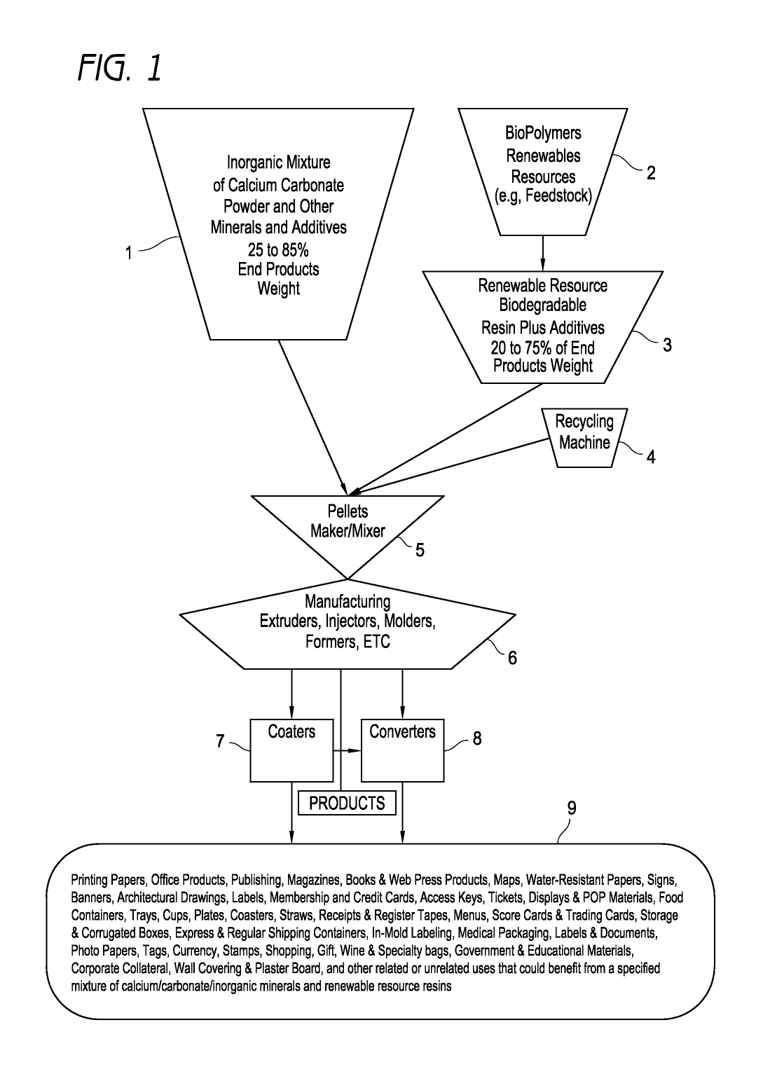

For a detailed understanding of an embodiment the method of making the composition of the disclosure, reference is made to the flow diagram in FIG. 1. As shown in 1, an inorganic mixture of calcium carbonate powder and other minerals and additives is formed. Biopolymer renewable resource 2 comprises a biodegradable polymer such as PLA. As illustrated in 3, the biopolymer resin is mixed with additives. The contents of 1 and 3 are mixed together in pellet maker/mixer 5 to form a biodegradable material composition. The pellet maker/mixer may be equipped with the ability to pelletize the material and may include, for example, a Banbury® mixer and a single screw or twin screw extruder. The mixing may take place in any suitable process, including heating the polymer component so that it flows, then thoroughly mixing in the other components such that all components are evenly dispersed within the biopolymer. The biodegradable material composition may be formed into pellets. Such pellets may be die cut or strand cut with a size range typically from 2-3 mm (or about 2 to about 3 mm).

The pellets may be processed according to any suitable processing methods including extrusion forming, injection molding, thermoforming, vacuum forming, injection molding, stretching, blow molding, extrusion, blow molding, and rotational molding or any other processing method known in the art 6. Optionally, the converted products may also undergo a coating process 7 and/or a further processing to form the final article. Such further processing may include plasma coating, metallization, dip coating, and/or any other secondary processes such as laminating heat sealing, ultrasonic welding or other typical secondary processes 8. Coating processes may include coating of the biodegradable composition with additional materials including, but not limited to polyvinyl alcohol, PLA, biopolyesters, acrylics, or any other suitable material. Through the process described above, the biodegradable material composition may be made into numerous end products as illustrated in 9.

The contents of the biodegradable material composition may be selected to achieve a variety of end products with desired properties. For example, a percentage of calcium carbonate between 45% and 60% (or about 45% and about 60%) by weight of the composition with the particle sizes described above may be suitable for paper or paper-like applications. According to another embodiment, a percentage of calcium carbonate between 30% and 45% (or about 30% and about 45%) by weight, preferably between 30% and 35% (or about 30% and about 35%) by weight, of the composition with the particle sizes described above may be suitable for food service product applications, which may include plastic cutlery (including forks, knives, spoons and sporks), cups, plates, bowls, and similar types of products. Other applications for the biodegradable material composition may include signs, packaging, boxes, food containers, bags, labels, maps, books, newspapers and magazine, trays, credit cards and room keys, architectural drawings, decoration, wall coverings, parts of insulation, moisture barriers, window coverings, office supplies, spiral binders, bottles, jars, various specialty containers, cups, medical uses, packaging of feminine hygiene products, sunglasses, soap wrapping, desk accessories, toys, cellular phone covers, films, as well as any application where the material may be suitable as a substitute for petroleum-based plastics.

Some suitable processing methods for processing the biodegradable material composition include, but are not limited to:

Plastics Extrusion, where a biodegradable material composition is melted and formed into a continuous profile, such as, for example, pipe/tubing, weather stripping, window frames, adhesive tape and wire insulation.

Thermoforming, where sheets of the biodegradable material composition are heated to a pliable forming temperature and formed to a specific shape in a mold, and trimmed to create a usable product. This primarily produces disposable cups, containers, lids, trays, blisters, clamshells, and other products for the food, medical, and general retail industries.

Vacuum Forming, which may be used for parts that are shallow in depth or where wall thickness is not critical to the function of the part, such as for transparent materials, unit doses of pharmaceuticals, or protective covers.

Blow Molding, where hot biodegradable material composition resin is pressurized into mold cavities, cooled and hardened, then ejected from the mold. This method may provide a wide variety of industrial or technical applications, such as toy wheels, automobile seat backs, ductwork, surf boards, bellows, fuel tanks, flower pots, automobile bumpers, double-walled tool cases, and cabinet panels.

Rotational Molding, which is similar to blow molding, but molds are slowly rotated into place continuously while cooling. Products that may be produced by this method may include storage tanks, bins and refuse containers, doll parts, road cones, footballs, helmets, rowing boats and kayak hulls, playground slides, and roofs.

According to a first example of an embodiment of the invention, a sample of biodegradable composition was created which included 45% by weight of wet ground calcium carbonate having two particle sizes—a first median particle size of 2 microns and a second median particle size of 0.7 microns as described above—mixed with 55% by weight of PLA, starch and other additives. The additives made up less than 5% of the total weight of the composition. The resulting samples were tested and demonstrated the following properties:

TABLE 1
SUMMARY OF PHYSICAL PROPERTIES OF
SAMPLE CONTAINING 45% BY
WT. CALCIUM CARBONATE

| Physical Property | ASTM Test Method | Values | |
|---|---|---|---|
| Tensile Strength at | D 638 | 10.4 | MPa |
| Max | | | |
| Tensile Elongation at | D 638 | 85% | |
| Break | | | |
| Tensile Modulus | D 638 | 477 | MPa |
| Flexural Modulus | D 790 | 483 | MPa |
| Flexural Strength | D 790 | 12.6 | MPa |
| Melt Flow Index | D 1238 | 6.2 g/10 min | |
| 190° C. at 2.16 Kg | | | |
| Gardner Impact | D 5420 | 18.1 | J |

Additionally, heat degradation was testing by inserting a sheeted and flat sample of a biodegradable composition containing 45% by weight of calcium carbonate and a sheeted and flat sample of PLA with no calcium carbonate into water heated to over 200° Fahrenheit. The sample containing 45% by weight of calcium carbonate showed no noticeable distortion or effects of that heat. The PLA sample containing no calcium carbonate showed immediate distortion and breakdown from the heated conditions. Accordingly, in one embodiment of the invention a biodegradable composition is provided having the same or better properties than those shown in Table 1 and improved heat performance over PLA.

The product formed through this example according to an embodiment, was able to obtain thicknesses as high as 56 mm, as well as thicknesses as low as of 7 mm. This is a comparable value to the thickness of high end paper stock, magazine cover stock, room key stock, sign and banner stock, and card stock, and is thus suitable for application such as these. The color of the end product having the composition of this example according to an embodiment was consistent and quality was comparable to existing plastic sheeting and signage, synthetic paper, high end pulp paper and certain other thermoplastic materials.

According to a second example of an embodiment of the invention, a sample of biodegradable composition was created which included 30% by weight of wet ground calcium carbonate having two particle sizes—a first median particle size of 2 microns and a second median particle size of 0.7 microns as described above—mixed with PLA, starch and other additives. The sample exhibited the following properties:

TABLE 2
SUMMARY OF PHYSICAL PROPERTIES OF
SAMPLE CONTAINING 30% BY
WT CALCIUM CARBONATE

| Physical Property | ASTM Test Method | Values | |
|---|---|---|---|
| Tensile Strength | D 638 | 41.2 | MPa |
| at Max | | | |
| Tensile Elongation | D 638 | 11% | |
| at Break | | | |
| Tensile Modulus | D 638 | 5,120 | MPa |
| Flexural Modulus | D 790 | 5,080 | MPa |
| Flexural Strength | D 790 | 58.1 | MPa |
| Melt Flow Index | D 1238 | 4.2 g/10 min | |
| 190° C. at 2.16 Kg | | | |
| Gardner Impact | D 5420 | 6.3 | J |
| Specific Gravity | D 792 | 1.58 | |

As can be seen from the above values, the composition exhibited high strength and toughness. This sample exhibited a higher tensile strength at maximum, higher tensile and flexural modulus, and higher flexural strength as compared to the composition of Example 1. Accordingly, in another embodiment of the invention a biodegradable composition is provided having the same or better properties than those shown in Table 2.

Various thicknesses or gauges of a third embodiment of a biodegradable composition a sample of biodegradable composition was created which included 45% by weight of wet ground calcium carbonate having two particle sizes—a first median particle size of 2 microns and a second median particle size of 0.7 microns as described above—mixed with PLA, starch and other additives. The samples were subjected to physical testing. Their properties are summarized below:

TABLE 3
SUMMARY OF PHYSICAL PROPERTIES OF
SAMPLE CONTAINING 45% BY
WT CALCIUM CARBONATE

| Physical | Sample | Sample | Sample | Sample |
|---|---|---|---|---|
| Properties | A | C | E | G |
| Instrumented | 0.10 | 0.31 | 1.40 | 2.59 |
| Impact | | | | |
| Top | | | | |
| Ra (millionths | 36 | 17 | 36 | 34 |
| of an inch) | | | | |
| Rz (millionths | 224 | 121 | 234 | 187 |
| of an inch) | | | | |
| Rmax (mil- | 285 | 160 | 314 | 213 |
| lionths | | | | |
| of an inch) | | | | |
| Pc (millionths | 335 | 584 | 292 | 241 |
| of an inch) | | | | |
| Sm (millionths | 0.003 | 0.002 | 0.003 | 0.004 |
| of an inch) | | | | |
| Bottom | | | | |
| Ra (millionths | 35 | 48 | 36 | 32 |
| of an inch) | | | | |
| Rz (millionths | 227 | 288 | 242 | 207 |
| of an inch) | | | | |
| Rmax (mil- | 297 | 488 | 380 | 275 |
| lionths | | | | |
| of an inch) | | | | |
| Pc (millionths | 386 | 254 | 310 | 373 |
| of an inch) | | | | |
| Sm (millionths | 0.003 | 0.004 | 0.003 | 0.003 |
| of an inch) | | | | |
| True Factor | 0.05257 | 0.05660 | 0.05764 | 0.05753 |
| (density at .001 | | | | |
| thick 1″ by 1″) | | | | |
| Tensile yield, | 2050 | 1812 | 1773 | 1757 |
| md (lbs) | | | | |
| Tensile rupture, | 1422 | 1201 | 1128 | 1079 |
| md (lbs) | | | | |
| % (stretch) | 14.4 | 16.6 | 24.6 | 16.2 |
| Elongation, md | | | | |
| Tensile yield, | 1197 | 1013 | 1136 | 1252 |
| td (lbs) | | | | |
| Tensile rupture, | n/a | n/a | 736 | 789 |
| td (lbs) | | | | |
| % (stretch) | 18.5 | 32.6 | 28.4 | 23.8 |
| Elongation, td | | | | |
| Flex, md (lbs) | n/a | n/a | 1157 | 1274 |
| Flex, td (lbs) | n/a | n/a | 760 | 724 |
| Initiated Tear, | 0.1 | 0.2 | 0.9 | 2.3 |
| md (lbs) | | | | |
| Initiated Tear, | 0.1 | 0.3 | 1.3 | 2.6 |
| td (lbs) | | | | |
| Uninitiated | 0.2 | 0.4 | 2.5 | 6.1 |
| Tear, md (lbs) | | | | |
| Uninitiated | 0.2 | 0.5 | 2.2 | 5.6 |
| Tear, td (lbs) | | | | |
| Gauge (mils) | 0.006 | 0.01 | 0.026 | 0.045 |

The samples according to the third example show improved tear, puncture, and heat resistance. The properties demonstrated with these samples are comparable to existing wood-based printing paper. As compared to other bio papers, the material is shown to be thinner than what may be produced. Also tear, puncture, printability and heat resistance is improved over the prior art.

The foregoing description of the invention includes preferred forms thereof. Modifications may be made thereto without departing from the scope of the invention. To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

What is claimed is:

1. A biodegradable material composition comprising:
a biodegradable polymer comprising at least polylactic acid, the biodegradable polymer comprising between about 20% and about 75% by weight of the composition;
an inorganic filler comprising calcium carbonate; and
additives comprising at least a plasticizer; and
wherein the calcium carbonate comprises between about 30% and about 65% by weight of the composition, and wherein the calcium carbonate comprises particles of calcium carbonate and the particles comprise a particle size distribution with at least two different median particle sizes.

2. The biodegradable material composition of claim 1, wherein the at least two different median particles sizes comprise:
a first median particle size; and
a second median particle size;
wherein the first median particle size is about 0.8 microns or less and the second median particle size is about 1 micron or more.

3. The biodegradable material composition of claim 2, wherein the first median particle size is about 0.8 microns or less and the second median particle size is about 1.5 microns or more.

4. The biodegradable material composition of claim 1, wherein the between about 30% and about 65% by weight calcium carbonate exhibits a bimodal particle size distribution consisting essentially of a first median particle size of about 0.8 microns or less and a second median particle size of about 1 micron or more.

5. The biodegradable material composition of claim 1, wherein the particles of calcium carbonate are wet ground.

6. The biodegradable material composition of claim 1, wherein the calcium carbonate comprises between about 30% and about 45% by weight of the composition.

7. The biodegradable material composition of claim 1, wherein the additives comprise between about 0.5% and about 20% by weight of the composition.

8. The biodegradable material composition of claim 1, wherein the composition has a tensile modulus of 477 MPa or more, as measured under ASTM D 638.

9. The biodegradable material composition of claim 1, wherein the additives further comprise a binder.

10. A food service product comprising:
a biodegradable polymer comprising polylactic acid, the biodegradable polymer comprising between about 20% and about 75% by weight of the food service product;
an inorganic filler comprising calcium carbonate; and
additives comprising between about 0.5% and about 20% by weight of the food service product, wherein the additives comprise a plasticizer;
wherein the calcium carbonate comprises between about 30% and about 45% by weight of the food service product and exhibits a bimodal particle size distribution having a first median particle size and a second median particle size.

11. The food service product of claim 10, wherein the food service product is cutlery.

12. The food service product of claim 11, wherein the first median particle is about 0.8 microns or less and the second median particle size is about 1 micron or more.

13. The food service product of claim 11, wherein the first median particle size is about 0.8 microns or less and the second median particle size is about 1.5 microns or more.

14. The food service product of claim 10, wherein the food service product is compostable.

15. A printable sheet comprising:
a biodegradable polymer comprising polylactic acid, the biodegradable polymer comprising between about 20% and about 75% by weight of the printable sheet;
an inorganic filler comprising calcium carbonate; and
additives comprising a plasticizer and a binder;
wherein the calcium carbonate comprises between about 30% and about 65% by weight of the printable sheet and exhibits a bimodal particle size distribution having a first median particle size and a second median particle size.

16. The printable sheet of claim 15, wherein the first median particle is about 0.8 microns or less and the second median particle size is about 1 micron or more.

17. The printable sheet of claim 16, wherein the first median particle size is about 0.8 microns or less and the second median particle size is about 1.5 microns or more.

18. The printable sheet of claim 15, wherein the calcium carbonate comprises between about 30% and about 45% by weight of the printable sheet.

19. The printable sheet of claim 15, wherein the printable sheet is compostable.

20. The printable sheet of claim 15, wherein the printable sheet has a tensile modulus of 477 MPa or more, as measured under ASTM D 638.
